(19) United States
(12) Patent Application Publication
(10) Pub. No.: US 2024/0382783 A1
(43) Pub. Date: Nov. 21, 2024

(54) DYNAMIC MANAGEMENT OF OXYGEN CONSUMPTION VIA MACHINE LEARNING

(71) Applicant: International Business Machines Corporation, Armonk, NY (US)

(72) Inventors: Jeremy R. Fox, Georgetown, TX (US); Alexander Reznicek, Troy, NY (US); Martin G. Keen, Cary, NC (US); Bahman Hekmatshoartabari, White Plains, NY (US)

(21) Appl. No.: 18/319,563

(22) Filed: May 18, 2023

(51) Int. Cl. A62B 9/00; A62B 7/00

(52) U.S. Cl. CPC A62B 9/006; A62B 7/00

(57) ABSTRACT

An approach for providing real-time information and guidance for oxygen management to a user operating a self-contained breathing apparatus (SCBA) is disclosed. The approach receives data from IoT devices associated with a user, analyzes the data using machine learning algorithms trained on a dataset of historical data and simulated scenarios. The approach generates an oxygen-use prediction based on the analyzing. Furthermore, the approach generates one or more recommendations based on the prediction and displaying the prediction and the recommendation on a HUD (head up display) of a user.

### BACKGROUND

The present invention relates generally to breathing air and more particularly managing oxygen consumption delivered by an apparatus via machine learning.

Firefighters are essential first responders in emergency situations involving fires. When responding to a fire, it is critical that firefighters have access to oxygen in order to effectively and safely extinguish the blaze. Oxygen is important for firefighters because it is necessary for their breathing equipment to function properly. Firefighting equipment, such as oxygen tanks, masks, and hoses, rely on oxygen in order to operate effectively. Without oxygen, these tools would be useless, and firefighters would be unable to use them to tackle the blaze.

### SUMMARY

Aspects of the present invention disclose a computer-implemented method, a computer system and computer program product for providing real-time information and guidance for oxygen management to a user operating a self-contained breathing apparatus (SCBA). The computer implemented method may be implemented by one or more computer processors and may include: continuously receiving data from one or more devices associated with a user; analyzing the data using machine learning algorithms trained on a dataset of historical data and simulated scenarios; generating an oxygen-use prediction based on the analyzing; generating a recommendation based on the prediction; and displaying the prediction and the recommendation.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

### BRIEF DESCRIPTION OF THE DRAWINGS

Preferred embodiments of the present invention will now be described, by way of example only, with reference to the following drawings, in which:

FIG. 1A is a diagram illustrating a high level overview of the functionality of the breathing environment, designated as 100, in accordance with an embodiment of the present invention;

FIG. 1B is a diagram illustrating a fighter pilot version of breathing mask 101, in accordance with one embodiment of the present invention;

FIG. 1C is a diagram illustrating an underwater version of breathing mask 101, in accordance with another embodiment of the present invention;

FIG. 2 is a high-level flowchart illustrating holistic operational steps of breathing component 111 as it relates to a firefighting scenario, in accordance with an embodiment of the present invention;

FIG. 3 are steps illustrating the model implementation of breathing environment 100 as it relates to a firefighting scenario, in accordance with an embodiment of the present invention;

FIG. 4 is a high-level flowchart illustrating the operation of breathing component 111 in an agnostic scenario, in accordance with another embodiment of the present invention; and

FIG. 5 depicts a block diagram, designated as 500 of components of a server computer capable of executing the breathing component 111 within the breathing environment 100, in accordance with an embodiment of the present invention.

### DETAILED DESCRIPTION

It can be challenging firefighters to track their oxygen levels because they are often in high-stress, fast-moving environments where it is difficult to continuously monitor their oxygen usage accurately and effectively. Firefighting involves physically demanding activities that can quickly deplete oxygen supplies, making it difficult for firefighters to gauge how much oxygen they are using. Additionally, the smoke and other environmental factors present in a fire can affect the accuracy of oxygen sensors, making it difficult to accurately track oxygen levels in real-time.

Embodiments of the present invention provides an approach for providing real-time information and guidance to firefighters on their route usage and oxygen management. One approach involves a holistic methods and systems to improving the safety and effectiveness of firefighters by utilizing wearable sensors and machine learning algorithms to monitor and predict their needs and environment. The system can incorporate sensors and wearable devices that can continuously monitor oxygen levels and other key health metrics. The system can include machine-learning algorithms that can analyze the data and generate predictions and recommendations for the firefighter. Additionally, the system can provide the predictions and recommendations to the firefighter in real time, such as through a head's up display (HUD) worn by the firefighters. It is noted that firefighting is one of many use cases for the present invention. However, embodiments may be used, but is not limited to, in the following fields and environments, spaceflight/suit, aircraft pilots, underwater diving and any situations (with limited oxygen supply) requiring respiratory function by users.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

### Breathing Environment Including Devices

It should be understood that the Figures are merely schematic and are not drawn to scale. It should also be understood that the same reference numerals are used throughout the Figures to indicate the same or similar parts.

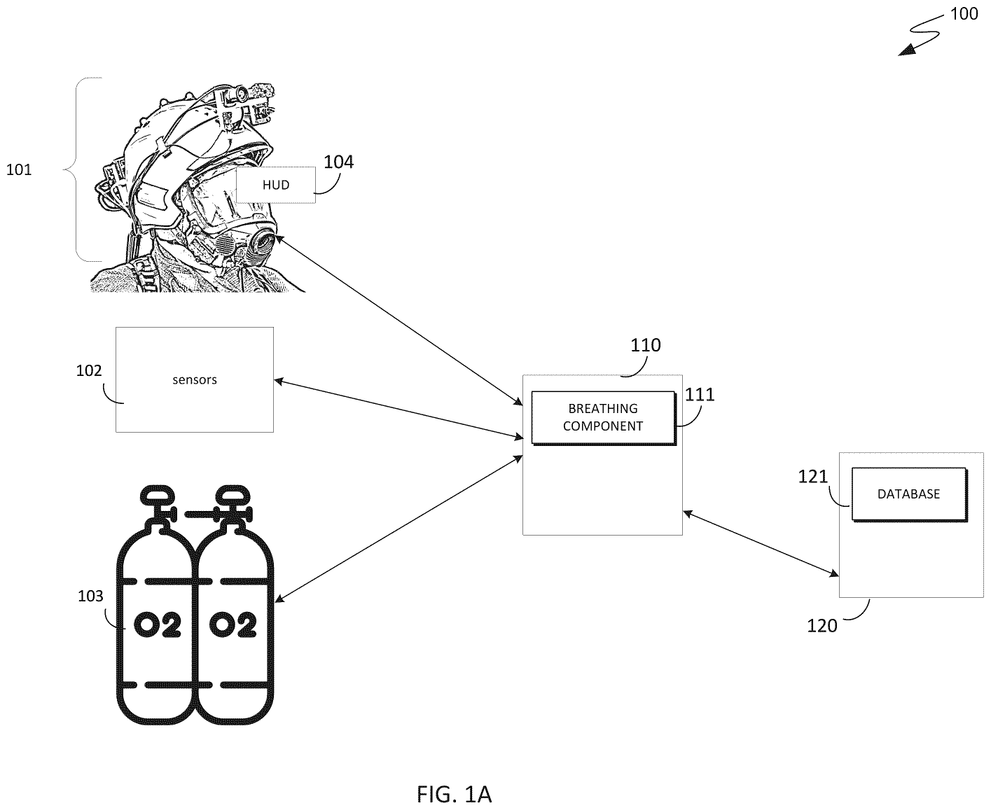

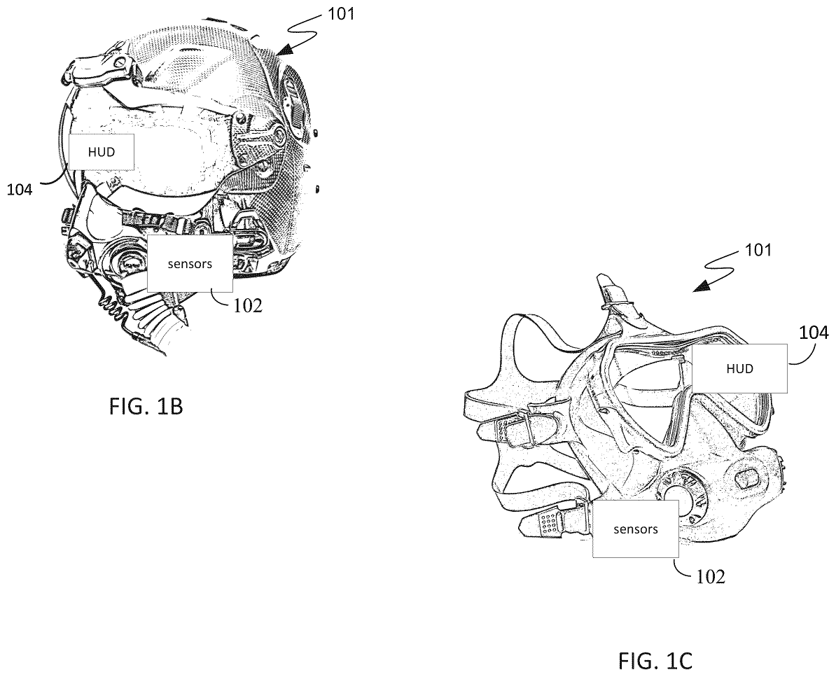

FIG. 1A is a diagram illustrating a high-level overview of the functionality of the breathing environment, designated as 100, in accordance with an embodiment of the present invention. A use case scenario of firefighting and/or firefighter will be referenced while describing the details of the present embodiment. Breathing environment 100 includes breathing mask 101, sensors 102, gas tank 103, breathing management module 110 and server 120.

Breathing mask 101 is an apparatus that allows oxygen and other gases to be transported from a storage tank (e.g., 103, etc.) into the lungs of a user. At the same time, breathing mask 101 completely covers the nose and mouth to seal off from the environment (e.g., prevent carbon mono/dioxide from reaching the user, etc.). In other embodiments, breathing mask 101 can be a helmet to completely seal off the face of the user from the environment (e.g., spaceflight, underwater diving, high-altitude flying, etc.).

Sensors 102 can be any smart device (e.g., IoT devices, wearable smartwatches, smartphones, IP cameras, etc.) used for detecting objects, chemical compounds/elements, auditory signals, electromagnetic signals and images. Sensors 102 can be categorized as environmental sensors, user bio sensors and user location sensors.

Environmental sensors are sensors used for measuring environmental conditions surrounding the user. For example, a user (i.e., firefighter) is inside a burning building and environmental sensors can measure the oxygen level within the building, measuring other gases, live-video camera, thermal sensors/imaging, microphones, and chemical/gas detector and things relating to the environment surrounding the user.

User biosensors are sensors used for measuring physiological activities relating to the user. For example, these sensors would include oxygen intake sensor (measures content of gases during the inhaling cycle), pulse sensors, body temperature sensors, and carbon dioxide sensor (measures content of gases during the exhaling cycle). Furthermore, user biosensors can include sensors for measuring gas flow rate of breathing regulator, sensor measuring tank capacity and sensor for measuring gas flow rate of breath mask.

User location sensors are sensors used to measure the location and/or motion of the user. For example, these sensors can include an accelerometer and GPS (global positioning sensor).

Another embodiment, sensors 102 may include wearable sensors or smart devices that continuously monitor oxygen levels and other key health metrics. These sensors can be integrated with digital health systems that can leverage the machine-learning algorithm to analyze the data and provide real-time feedback on the firefighter's oxygen levels and overall health status. This can help firefighters better understand their oxygen usage and identify opportunities to conserve oxygen and reduce the risk of oxygen depletion.

Gas tank 103 is one or more storage units where various gases (e.g., oxygen, nitrogen, etc.) used for breathing are initially stored and are eventually to be utilized by breathing mask 101. There are connections (i.e., tubes) that allows the delivery of gas from 103 to breathing mask 101. Furthermore, there can be a breathing regulator equipped onto the gas tank that regulates the flow rate and/or amount of gas to be delivered to mask 101. The breathing regulator can be electro-mechanical and remotely controlled (e.g., WI-FI, Bluetooth, etc.) by either breathing management module 110 or breathing mask 101.

HUD 104 is a heads up display (e.g., LCD display, AR display, etc.) configured to display, but is not limited to, biomarkers, oxygen consumption level by user, vital life signs of users (e.g., heart rate, temperature, etc.), optimal route for firefighter to escape, route showing location of people trapped in a building and oxygen level left in the gas tank of the user. It is noted that HUD 104 can function as an AR (artificial reality) display by superimposing digital information (e.g., text, pictures, etc.) onto the mask without impairing the view of the user.

Breathing management module 110 includes breathing component 111. Breathing management module 110 is a computerized device capable of executing breathing component 111. Breathing management module 110 is capable of communicating data between breathing mask 101, sensors 102, gas tank 103 and training server 120.

Breathing component 111 provides the following, but not limited to, capability of i) utilize oxygen tracking with tracking digital health biomarkers within a firefighter's body to help firefighters conserve oxygen and reduce the risk of oxygen depletion, ii) train machine learning algorithms on historical data and simulated scenarios to learn the patterns and trends associated with safe and effective firefighting, iii) analyze and process the data from sensors and wearable devices worn by firefighters, iv) make predictions and recommendations to the firefighter in real time and v) provide training and education on the importance of oxygen conservation and the potential risks of oxygen depletion.

### Capabilities and Functionality Of Module

### Continuous Monitoring Oxygen Usage Rates:

Another goal, previously mention is the ability to quickly and accurately monitor oxygen levels in real-time and take proactive steps to regulate the amount of oxygen provided to firefighters based on their individual needs and health status. This can help firefighters avoid oxygen depletion, which can be dangerous or even life-threatening in a high-stress environments.

### Proactive Calming for Oxygen Conservation:

To promote means of calming firefighters and conserving oxygen, an organization (e.g., firefighting, underwater association, military, etc.) can provide training and education on the importance of oxygen conservation and the potential risks of oxygen depletion. This can include information on the signs and symptoms of oxygen depletion, as well as strategies for conserving oxygen and managing stress in high-pressure situations. Additionally, the organization can implement policies and procedures that support oxygen conservation, such as providing regular breaks or rest periods for firefighters to recover and recharge.

### Firefighting Route Detection:

While pulse oximetry is a valuable tool for tracking oxygen saturation levels in a person's biomarkers, it is not the only tool available. Additionally, other methods such as fire fighting and route detection can be used to monitor oxygen saturation levels in a more efficient manner. For example, firefighting utilizes sensors to detect oxygen levels in an area and can provide real-time feedback. Similarly, route detection uses sensors to track oxygen levels in a person's environment, allowing for more accurate tracking of oxygen saturation levels. In both instances, the data is more accurate and provides a more comprehensive view of oxygen saturation levels.

Furthermore, while the proposed OBM (oximetry digital biomarkers) toolbox is designed to analyze continuous oxygen saturation time series, it is limited in scope and does not allow for the more robust analysis that firefighting and route detection provide. Therefore, while pulse oximetry is a valuable tool for monitoring oxygen saturation levels, it is not the only tool available and should be supplemented with more advanced methods such as firefighting and route detection. It is noted that the OBM toolbox (referenced at the beginning paragraph) refers to existing software (e.g., built with Python, etc.) that was used to in the research field of OSA (obstructive sleep apnea). The application of such software including toolbox can be applied to this invention but with caution that it should not be relied as the only tool for tracking oxygen saturation level.

Embodiment(s) of the present invention can reside on breathing management module 110.

Training server 120 can be a standalone computing device, a management server, a web server, a mobile computing device, or any other electronic device or computing system capable of receiving, sending, and processing data. Training server 120 can be utilized to run simulations/scenarios as in a machine learning and/or artificial intelligence capacity to assist with training breathing component 111 to make a more accurate prediction and/or manage oxygen consumption/tracking of the user. It is noted that training server 120 is optional as long as breathing management module 110 has the computing capability of using machine learning to analyze large amounts of data (e.g., historical and real-time, make predictions and recommendations) and has access to database 121.

In other embodiments, training server 120 can represent a server computing system utilizing multiple computers as a server system, such as in a cloud computing environment. In another embodiment, training server 120 can be a laptop computer, a tablet computer, a netbook computer, a personal computer (PC), a desktop computer, a personal digital assistant (PDA), a smart phone, or any other programmable electronic device capable of communicating other computing devices (not shown) within breathing environment 100. In another embodiment, training server 120 represents a computing system utilizing clustered computers and components (e.g., database server computers, application server computers, etc.) that act as a single pool of seamless resources when accessed within breathing environment 100. It is noted that training server 120 includes database 121.

Database 121 is a repository for data used by breathing component 111. Database 121 can be implemented with any type of storage device capable of storing data and configuration files that can be accessed and utilized by server 110, such as a database server, a hard disk drive, or a flash memory. Database 121 uses one or more of a plurality of techniques known in the art to store a plurality of information. In the depicted embodiment, database 121 resides on server 110. In another embodiment, database 121 may reside elsewhere within breathing environment 100, provided that breathing component 111 has access to database 121. Database 121 may store information associated with, but is not limited to, knowledge corpus, ratio of gases safe for breathing, tracking location, training data related to the occupation of the user (e.g., firefighting, space flight, etc.), simulations and scenarios relating to the occupation of the user, weather related data, map related data, displaying routes on the HUD of breathing mask 101, historical data of buildings, ocean currents, water pressure and training data of users where they were being trained/tested in a simulated environment).

FIG. 1B and 1C illustrates different variations of breathing mask 101, in accordance with an embodiment of the present invention. Breathing mask 101 in FIG. 1B is configured for aircraft fighter pilot capacity and contains HUD 104. HUD 104 can be configured to display vital life signs for the user, oxygen consumption for the user and other information related to the role functionality specific to the user and/or mission. Sensors 102 can be integrated into breathing mask 101 or attached to breathing mask 101.

Breathing mask 101 in FIG. 1C is configured for underwater diving functionality and contains HUD 104. HUD 104 is a heads up display configured to display, but is not limited to, biomarkers, oxygen consumption level by user, vital life signs of users (e.g., heart rate, temperature, etc.), route of ocean current, speed of ocean current nearby and oxygen level left in the gas tank of the user. Sensors 102 can be integrated into breathing mask 101 or attached to breathing mask 101.

### Overall Functionality of One Embodiment

As it relates to FIG. 1A and FIG. 1B and FIG. 1C, a firefighting situation will be described in greater detail to illustrate one embodiment. As previously mentioned that the main concept and goals of this particular embodiment, relating to firefighting scenario/use case, includes the following: 1) developing wearable sensors or smart devices that can continuously monitor oxygen levels and other key health metrics; 2) designing algorithms that can analyze the data from the sensors and provide real-time feedback on the firefighter's oxygen levels and overall health status; 3) developing and implementing protocols and policies for the use of the technologies; 4) developing a means of providing the predictions and recommendations to the firefighters in real time, such as a HUD or other display device; 5) developing and refining machine learning algorithms trained on a dataset of historical data and simulated scenarios; 6) designing a system that can monitor and evaluate the impact of the technologies on firefighters' safety and effectiveness; 7) incorporating new technologies and innovations into the system, as well as making adjustments to existing technologies based on user feedback and changing needs; and 8) training firefighters on how to use the technologies and protocols effectively (i.e., situational awareness).

### Machine-Learning Algorithm

In order to achieve the above concept and goals, embodiment would include a combination of specific hardware (e.g., breathing masks, tank, HUD, etc.) and software (i.e., breathing component 111) to work together seamlessly. Furthermore, there is a machine-learning algorithm component of breathing component 111 that may require training and the preferred embodiment is for that machine-learning algorithm to be trained, initially. Some machine-learning algorithm, such as, but not limited to, linear regression, logistic regression, decision tree, artificial neural network, k-Nearest Neighbors and K-means be all be utilized, depending on the user who is in charge of the training the algorithm. It is noted that there can be more than one machine-learning algorithm. For example, one machine-learning algorithm (along with a corresponding machine-learning model as a result of the algorithm) can be associated with teaching the user with the best practice for entering a burning building when it's full of smoke and haze.

This initial training will involve integrating historical and real-time data so that the machine-learning algorithm can generate predictions and recommendations (i.e., models) based on the analysis of the data.

The predictions and recommendations (based on the machine-learning model) can include, but it is not limited to, identifying opportunities to conserve oxygen usage and dynamically manage oxygen usage unique to that particular user (e.g., firefighter, pilot, etc.) based on his/her health status.

In other embodiments, as it relates to underwater diving, predictions and recommendations may allow divers to conserve oxygen consumption and train them to develop a certain routine mobility movement (i.e., slow and steady leg kicks) that conforms to the least use of oxygen.

In other embodiments (not relating to firefighting situation), the prediction and recommendation from the machine-learning algorithm can include the following:

### Monitoring Oxygen Levels:

This use case, medical/hospital environment, involves monitoring a patient's oxygen levels in real time to ensure that they are within a healthy range and to detect any sudden changes. This can be done through a device (i.e., sensors 102) that collects data from the patient's oxygen level monitor, and then sends it to a healthcare provider for analysis.

### Preemptively Adjusting Oxygen Levels:

This use case involves using machine learning algorithms to detect changes in a patient's oxygen levels and to preemptively adjust the oxygen levels to prevent any medical emergencies. This could be done through a device that collects data from the patient's oxygen level monitor and then uses machine learning algorithms to adjust the oxygen levels accordingly.

### Automated Oxygen Delivery:

This use case involves using a device to autonomously deliver the right amount of oxygen to the patient based on their health status. This could involve using sensors to detect the patient's oxygen levels and then automatically delivering the appropriate amount of oxygen without any manual intervention.

### Automated Oxygen Therapy:

This use case involves using a device to autonomously provide oxygen therapy to the patient based on their health status. This could involve using sensors to detect the patient's oxygen levels and then automatically providing the appropriate oxygen therapy without any manual intervention. This could evolve autonomously and ameliorate the delivery over time.

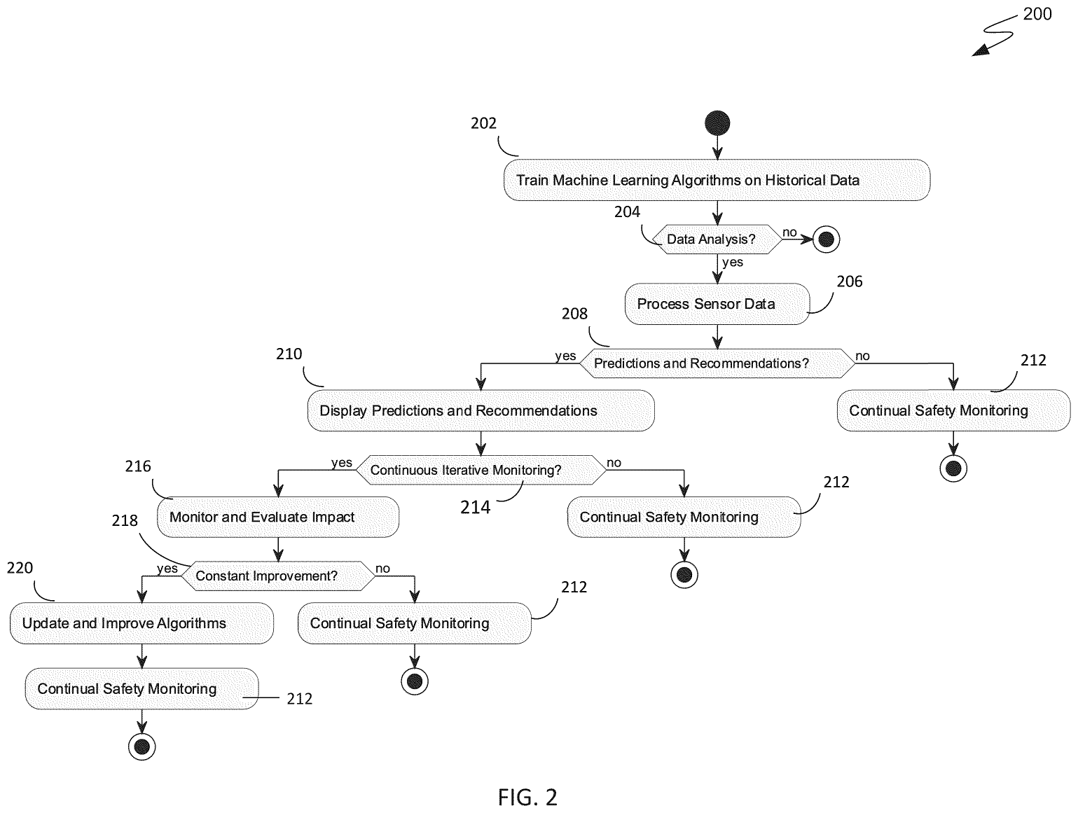

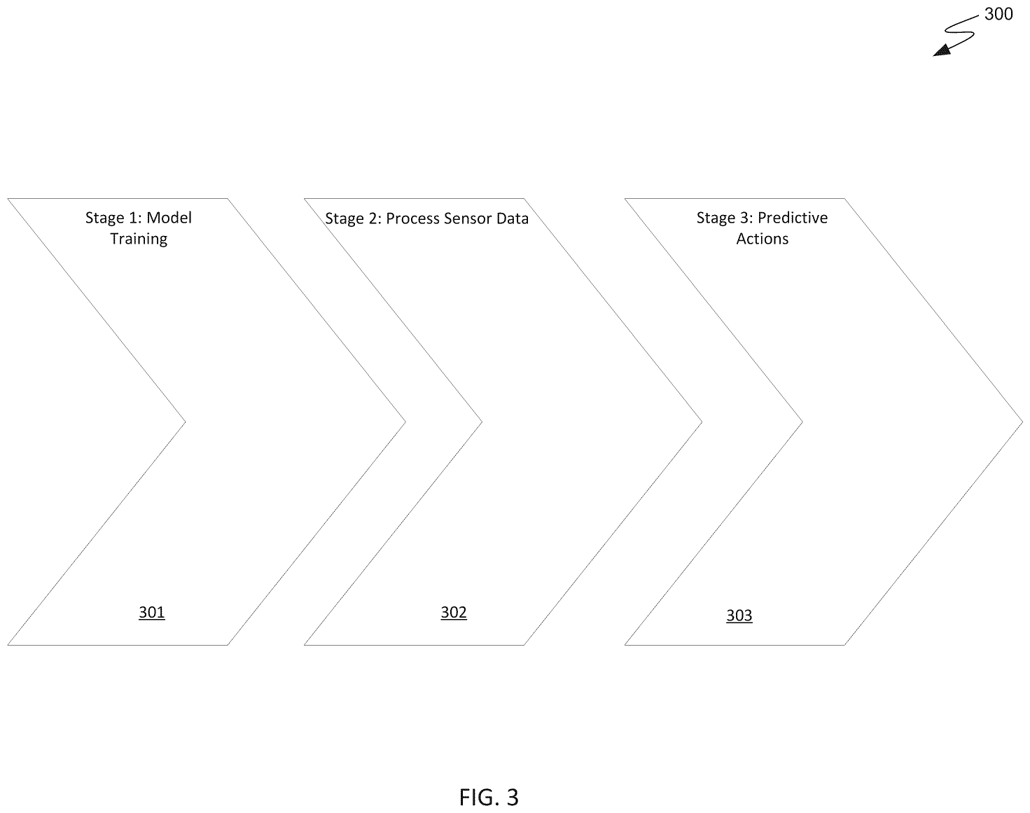

Training and utilizing the machine-learning algorithm and model relating to the machine-learning algorithm will be explained in greater details as it relates to FIG. 2 and FIG. 3.

### Data Elements for Firefighting

The data elements to be implemented by an embodiment of the software (relating to a firefighting scenario) could include the following:

Oxygen levels: This data element would include information on the concentration of oxygen in the air, measured by sensors embedded in the firefighter's clothing and equipment. This data could be used to monitor the firefighter's oxygen levels in real time and to make predictions and recommendations on how to conserve oxygen.

Biosensor Health indicators: This data element would include information on the firefighter's health, such as heart rate, body temperature, and other vital signs. This data could be collected using sensors and wearable devices and could be used to monitor the firefighter's health in real time and to alert them to potential health issues.

Physical Location and Movement Pattern: This data element would include information on the firefighter's location and movement, such as their position and orientation, speed, and acceleration. This data could be collected using sensors and wearable devices and could be used to provide real-time updates on the firefighter's location and movement to the command center and other stakeholders.

IoT Enabled Environment: This data element would include information on the environment in which the firefighter is operating, such as the intensity of the fire, the presence of obstacles, and the availability of oxygen. This data could be collected using sensors and wearable devices and could be used to make predictions and recommendations on the best route for the firefighter to take and the best approach to oxygen conservation.

It is noted that the data elements from the above firefighting scenario can be adapted for use in other situations: underwater diving, space flight, hospital/medical triage care, etc. For example, the data element relating to “physical location and movement pattern” may be adapted for underwater diving, wherein the physical location and movement pattern can correspond to plan dive sites.

### Machine Learning Model Implementation

FIG. 2 is a high-level flowchart illustrating a holistic operational step of breathing component 111 as it relates to a firefighting scenario, designated 200, in accordance with one embodiment of the present invention.

Model training (steps 202-204): Train the machine-learning algorithm on a large dataset of historical data and simulated scenarios to learn the patterns and trends associated with safe and effective firefighting. This could include data on the intensity of fires, the availability of oxygen, and the presence of obstacles. It is noted that there can be more than one machine-learning algorithm. For example, one machine-learning algorithm (along with a corresponding machine-learning model as a result of the algorithm) can be associated with teaching the user with the best practice for entering a burning building when it's full of smoke and haze.

Process sensor data (step 206): Use the trained algorithms to analyze and process the data from sensors and wearable devices worn by firefighters. This could include sensors that measure oxygen levels, heart rate, body temperature, and other health indicators, as well as sensors that provide information about the firefighter's location and environment.

Predictive actions recommendations (decision step 208): Embodiment can decide if it should make prediction and recommendation at this point. Sometimes, there is not enough data and/or not enough simulations to make a prediction and/or recommendation. If the decision is “YES” (i.e., there is enough data to make recommendation), then embodiment would proceed to step 210. If the decision is “NO”, then embodiment would proceed to step 212.

Display prediction and recommendations (step 210): Use the algorithms to make predictions and recommendations to the firefighter in real time. This could include suggesting the best route for the firefighter to take, alerting them to opportunities to conserve oxygen, and detecting potential health issues. The recommendations will be displayed and/or communicated to the firefighter via HUD 104 since they can be easily accessed and understood. The HUD could provide real-time alerts and guidance to the firefighter, helping them to make more informed decisions and take the best possible approach to their tasks.

Continuous iterative monitoring (decision step 214): Monitor and evaluate the impact of the AI on the safety and effectiveness of the firefighters. This could include collecting data on the algorithms' performance and the feedback from firefighters and other stakeholders. If the decision is “YES”, then embodiment would proceed to step 216. If the decision is “NO”, then embodiment would proceed to step 212.

Monitor and Evaluate Impact (step 216): System will monitor and evaluate the impact of the AI on the safety and effectiveness of the firefighters. This could include further collection of data on the algorithms' performance and the feedback from firefighters and other stakeholders.

Opportunities for constant improvement (decision step 218): System/users can/will evaluate whether embodiment should be constantly refined and improved. If the decision is “YES”, then embodiment would proceed to step 220. If the decision is “NO”, then embodiment would proceed to step 212.

Update and Improve algorithm (step 220): Continuously update and improve the algorithms based on ongoing research and evaluation. This could involve incorporating new data and insights into the training process, as well as making adjustments to the algorithms based on user feedback and changing needs.

Continual Safety Monitoring (steps 212): AI can help to improve the safety and effectiveness of firefighters by providing them with real-time information and guidance on their route usage and oxygen management. By using machine-learning algorithm(s) to analyze and process the data from sensors and wearable devices, we can help firefighters to make more informed decisions and take the best possible approach to their tasks.

### Model Implementation

FIG. 3 are steps illustrating the model implementation of breathing environment 100, designated as 300, in accordance with an embodiment of the present invention.

### Stage 1: Model Training

Block 301 of FIG. 3: Supervised learning is a type of machine learning algorithm used to identify patterns and trends from labeled data. In this stage, the algorithm would be trained with historical data and simulated scenarios to learn the patterns and trends associated with safe and effective firefighting. The algorithm would use the labeled data to develop a model that can accurately identify and predict the best practices for firefighting (or another occupation) based on the given data. It is noted that the model(s) can be specific to a user (e.g., profile for user_A, profile for user_B, etc.) or can be a generic model (i.e., not specific to a user) but specific for one occupation, such as, firefighting, underwater diving, fighter pilots and astronauts.

For example, the algorithm could be trained with data on the intensity of fires, the availability of oxygen, and the presence of obstacles. The algorithm would then use this data to identify patterns and trends in order to develop a predictive model that can accurately identify the best practices for firefighting based on the given data.

### Stage 2: Process Sensor Data

Block 302 of FIG. 3: Unsupervised learning is a type of machine learning algorithm used to identify patterns and trends from unlabeled data. In this stage, the algorithm would be used to analyze and process the data from sensors and wearable devices worn by firefighters. The algorithm would use the unlabeled data to develop a model that can accurately identify patterns and trends in the data.

For example, the algorithm could be used to analyze data from sensors that measure oxygen levels, heart rate, body temperature, and other health indicators, as well as sensors that provide information about the firefighter's location and environment. The algorithm would then use this data to identify patterns and trends in order to develop a model that can accurately detect potential health issues and suggest the best route for the firefighter (or another occupation) to take.

### Stage 3: Predictive Actions Recommendations

Block 303 of FIG. 3: Reinforcement learning is a type of machine learning algorithm used to identify the best actions to take in a given situation. In this stage, the algorithm would be used to make predictions and recommendations to the firefighter in real time. The algorithm would use the data from the sensors and the environment to determine the best course of action for the firefighter.

For example, the algorithm could suggest strategies for conserving oxygen and managing stress in high-pressure situations, as well as alerting the firefighter to potential health issues and opportunities to conserve oxygen. The algorithm would then use this data to identify the best course of action for the firefighter and provide real-time feedback on the firefighter's oxygen levels and overall health status.

### Flowchart

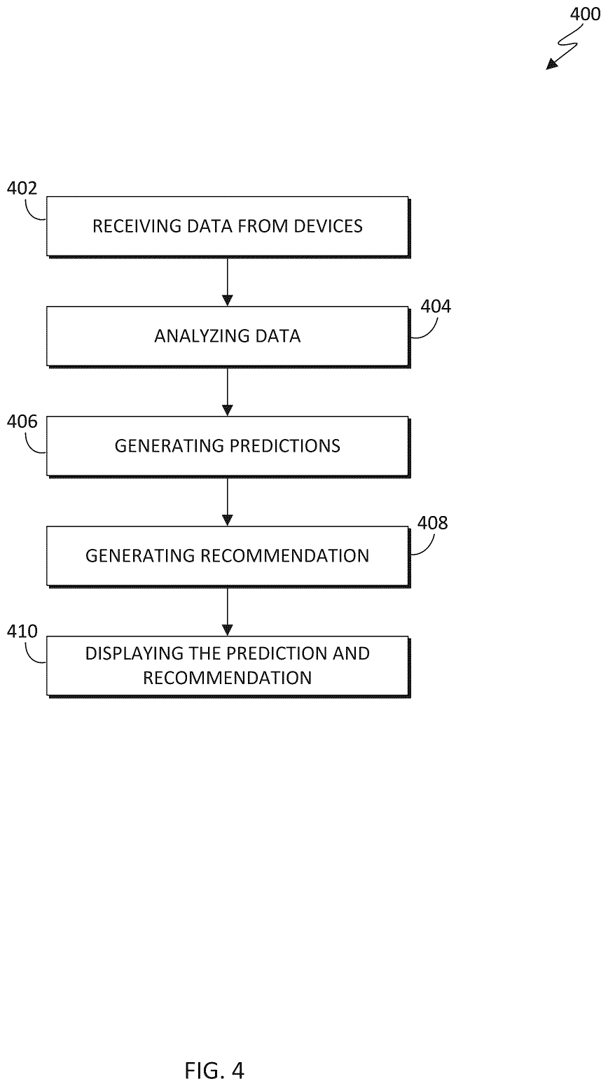

FIG. 4 is a high-level flowchart illustrating the operation of breathing component 111, designated as 400, in accordance with another embodiment of the present invention.

A use case of firefighting will be used to illustrate the steps. A group of firefighters (e.g., firefighter_1, firefighter_2, etc.) has been called to a multi-story burning building (building_A). Each firefighter is equipped with devices (e.g., breathing mask 101, sensors 102, gas tank 103 and breathing module 110 from FIG. 1) and firefighting gear (e.g., axe, flame retardant clothing, etc.).

Breathing component 111 receives data from various devices (step 402). In an embodiment, breathing component 111, continuously receives data from sensor devices (e.g., environmental sensor, user biosensors and user location sensor). Referring to the previous presented use case scenario of building_A, breathing module of 110 of firefighter_1 will start receiving various data from sensors 102. The data can include, but is it not limited to, temperature inside the building, number of occupants still in building_A, location of other firefighters, oxygen level of oxygen tank of firefighter_1 and biological status of firefighter_1.

Breathing component 111 analyzes the received data (step 404). In an embodiment, breathing component 111, leveraging existing machine-learning algorithm to analyze the real time data and if available other data such as, but not limited to, historical data of building_A and training data of firefighter_1 (wherein the firefighter were being trained/tested in a simulated environment). Training data specific to a firefighter can include, how that particular firefighter performed (e.g., how much oxygen was used, how tired was the firefighter, endurance, etc.) during a previous simulated training environment and/or from a previous real actual firefighting scenario. It is noted that the above scenario can be adapted for other use case for marine, space and sky environment.

It is noted that if no model profile exists for the user (i.e., firefighter_1) then it is possible for embodiment to create a new model profile and dynamically learn the behavior of firefighter_1 via machine-learning algorithm base on the real-time data analysis.

Breathing component 111 generates predictions (step 406). In an embodiment, breathing component 111 generates one or more predictions. For example, the one or more predictions can include, but not limited to, identifying opportunities to conserve oxygen usage and dynamically manage oxygen usage unique to that particular firefighter (or another occupation) based on his/her health status.

Breathing component 111 generates recommendations (step 408). In an embodiment, breathing component 111 generates one or more recommendations based on the prediction. For example, the one or more recommendations can include, but not limited to, suggesting the best route for the firefighter to take, alerting them to opportunities to conserve oxygen, and detecting potential health issues.

Breathing component 111 displaying the predictions and recommendation (step 410). In an embodiment, breathing component 111, displays the prediction and the recommendation on a head's up display (HUD) worn by the user. For example, the recommendation from step 408, such as, suggesting a new route, can be displayed superimposed as AR style on the helmet of the firefighter (i.e., breathing mask 101), as not to block their main view.

### OTHER EMBODIMENTS AND COMMENTS

Other embodiments of the present invention may include the following method, steps and/or systems:

Alternatively, the proposed concept/steps/methods and systems may be summarized in a nutshell in the following clauses:
1. A method of providing real-time information and guidance to firefighters on their route usage and oxygen management, comprising the steps;
   collecting data from sensors and wearable devices worn by firefighters,
   analyzing the data using machine learning algorithms trained on a dataset of historical data and simulated scenarios,
   generating predictions and recommendations based on the analysis of the data, and
   displaying the predictions and recommendations on a head's up display (HUD) worn by the firefighter.
2. A system for providing real-time information and guidance to firefighters on their route usage and oxygen management, comprising:
   sensors and wearable devices embedded in the firefighter's clothing and equipment,
   a command center that receives and processes data from the sensors and wearable devices,
   machine learning algorithms trained on a dataset of historical data and simulated scenarios, and
   a HUD worn by the firefighter that displays predictions and recommendations generated by the algorithms.
3. A method of improving the safety and effectiveness of firefighters, comprising the steps of:
   collecting data from sensors and wearable devices worn by firefighters,
   analyzing the data using machine learning algorithms trained on a dataset of historical data and simulated scenarios,
   generating predictions and recommendations based on the analysis of the data, and
   providing the predictions and recommendations to the firefighters in real time.
4. A system for improving the safety and effectiveness of firefighters, comprising:
   sensors and wearable devices embedded in the firefighter's clothing and equipment,
   a command center that receives and processes data from the sensors and wearable devices,
   machine learning algorithms trained on a dataset of historical data and simulated scenarios, and
   a means of providing the predictions and recommendations to the firefighters in real time, such as a HUD or other display device.
5. A method of conserving oxygen for firefighters, comprising the steps of:
   collecting data from sensors and wearable devices worn by firefighters,
   analyzing the data using machine learning algorithms trained on a dataset of historical data and simulated scenarios,
   generating predictions and recommendations based on the analysis of the data, and
   providing the predictions and recommendations to the firefighters in real time, with the aim of conserving oxygen and extending the time that the firefighters can spend in the field.
6. A system for conserving oxygen for firefighters, comprising:
   sensors and wearable devices embedded in the firefighter's clothing and equipment,
   a command center that receives and processes data from the sensors and wearable devices,
   machine learning algorithms trained on a dataset of historical data and simulated scenarios, and
   a means of providing the predictions and recommendations to the firefighters in real time, such as a HUD or other display device, with the aim of conserving oxygen and extending the time that the firefighters can spend in the field.

### Hardware Environment

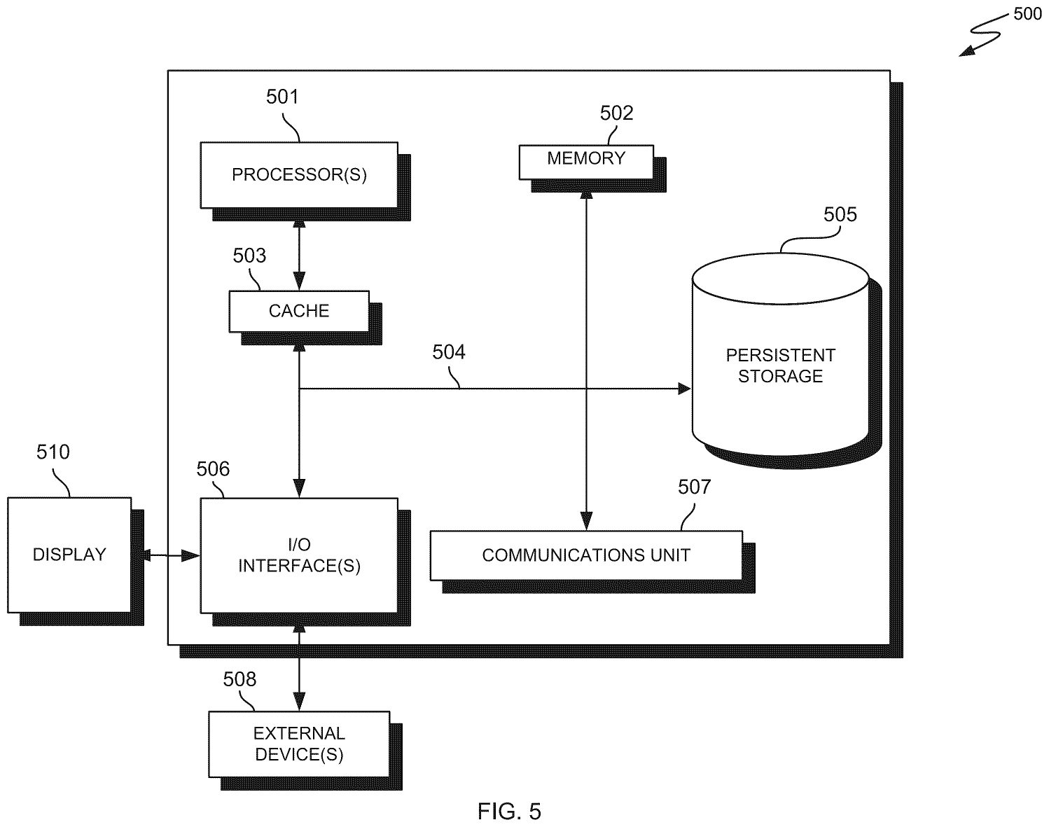

FIG. 5 depicts a block diagram, designated as 500 of components of a server computer capable of executing the breathing component 111 within the breathing environment 100, in accordance with an embodiment of the present invention. It should be appreciated that FIG. 5 provides only an illustration of one implementation and does not imply any limitations with regard to the environments in which different embodiments may be implemented. Many modifications to the depicted environment may be made.

FIG. 5 includes processor(s) 501, cache 503, memory 502, persistent storage 505, communications unit 507, input/output (I/O) interface(s) 506, and communications fabric 504. Communications fabric 504 provides communications between cache 503, memory 502, persistent storage 505, communications unit 507, and input/output (I/O) interface(s) 506. Communications fabric 504 can be implemented with any architecture designed for passing data and/or control information between processors (such as microprocessors, communications and network processors, etc.), system memory, peripheral devices, and any other hardware components within a system. For example, communications fabric 504 can be implemented with one or more buses or a crossbar switch.

Memory 502 and persistent storage 505 are computer readable storage media. In this embodiment, memory 502 includes random access memory (RAM). In general, memory 502 can include any suitable volatile or non-volatile computer readable storage media. Cache 503 is a fast memory that enhances the performance of processor(s) 501 by holding recently accessed data, and data near recently accessed data, from memory 502.

Program instructions and data (e.g., software and data x10) used to practice embodiments of the present invention may be stored in persistent storage 505 and in memory 502 for execution by one or more of the respective processor(s) 501 via cache 503. In an embodiment, persistent storage 505 includes a magnetic hard disk drive. Alternatively, or in addition to a magnetic hard disk drive, persistent storage 505 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 505 may also be removable. For example, a removable hard drive may be used for persistent storage 505. Other examples include optical and magnetic disks, thumb drives, and smart cards that are inserted into a drive for transfer onto another computer readable storage medium that is also part of persistent storage 505. Breathing component 111 can be stored in persistent storage 505 for access and/or execution by one or more of the respective processor(s) 501 via cache 503.

Communications unit 507, in these examples, provides for communications with other data processing systems or devices. In these examples, communications unit 507 includes one or more network interface cards. Communications unit 507 may provide communications through the use of either or both physical and wireless communications links. Program instructions and data (e.g., Breathing component 111) used to practice embodiments of the present invention may be downloaded to persistent storage 505 through communications unit 507.

I/O interface(s) 506 allows for input and output of data with other devices that may be connected to each computer system. For example, I/O interface(s) 506 may provide a connection to external device(s) 508, such as a keyboard, a keypad, a touch screen, and/or some other suitable input device. External device(s) 508 can also include portable computer readable storage media, such as, for example, thumb drives, portable optical or magnetic disks, and memory cards. Program instructions and data (e.g., Breathing component 111) used to practice embodiments of the present invention can be stored on such portable computer readable storage media and can be loaded onto persistent storage 505 via I/O interface(s) 506. I/O interface(s) 506 also connects to display 510.

Display 510 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method of providing real-time information and guidance for oxygen management to a user operating a self-contained breathing apparatus (SCBA), the method comprising:
continuously receiving data from one or more devices associated with a user;
analyzing the data using machine learning algorithms trained on a dataset of historical data and simulated scenarios;
generating an oxygen-use prediction based on the analyzing;
generating a recommendation based on the prediction; and
displaying the prediction and the recommendation.

2. The method of claim 1, wherein the one or more devices further comprises, environmental sensors, biosensors and user location sensors.

3. The method of claim 1, wherein the historical data consisting of how the user performed in a previous live situation relating to a profession of the user.

4. The method of claim 1, wherein the simulated scenarios consisting of the user specific training data associated with training exercise/simulations.

5. The method of claim 1, wherein the one or more predictions further comprises, identifying opportunities to conserve oxygen and dynamically manage oxygen usage.

6. The method of claim 1, wherein the one or more recommendation further comprises, suggesting best route for the user to take during a live situation and alerting users to opportunities to conserve oxygen.

7. The method of claim 1, wherein the displaying the prediction and the recommendation further comprising:
displaying on a head's up display (HUD) worn by the user of the recommendation.

8. A computer program product for providing real-time information and guidance for oxygen management to a user operating a self-contained breathing apparatus (SCBA), the computer program product comprising:
one or more computer readable storage media having computer-readable program instructions stored on the one or more computer readable storage media, said program instructions executes a computer-implemented method comprising the steps of:
continuously receiving data from one or more devices associated with a user;
analyzing the data using machine learning algorithms trained on a dataset of historical data and simulated scenarios;
generating an oxygen-use prediction based on the analyzing;
generating a recommendation based on the prediction; and
displaying the prediction and the recommendation.

9. The computer program product of claim 8, wherein the one or more devices further comprises, environmental sensors, biosensors and user location sensors.

10. The computer program product of claim 8, wherein the historical data consisting of how the user performed in a previous live situation relating to a profession of the user.

11. The computer program product of claim 8, wherein the simulated scenarios consisting of the user specific training data associated with training exercise/simulations.

12. The computer program product of claim 8, wherein the one or more predictions further comprises, identifying opportunities to conserve oxygen and dynamically manage oxygen usage.

13. The computer program product of claim 8, wherein the one or more recommendation further comprises, suggesting best route for the user to take during a live situation and alerting users to opportunities to conserve oxygen.

14. The computer program product of claim 8, wherein the displaying the prediction and the recommendation further comprising:
displaying on a head's up display (HUD) worn by the user of the recommendation.

15. A computer system for providing real-time information and guidance for oxygen management to a user operating a self-contained breathing apparatus (SCBA), the computer system comprising:
one or more computer processors;
one or more computer readable storage media; and
program instructions stored on the one or more computer readable storage media for execution by at least one of the one or more computer processors, said program instructions executes a computer-implemented method comprising the steps of:
continuously receiving data from one or more devices associated with a user;
analyzing the data using machine learning algorithms trained on a dataset of historical data and simulated scenarios;
generating an oxygen-use prediction based on the analyzing;
generating a recommendation based on the prediction; and
displaying the prediction and the recommendation.

16. The computer system of claim 15, wherein the one or more devices further comprises, environmental sensors, biosensors and user location sensors.

17. The computer system of claim 15, wherein the historical data consisting of how the user performed in a previous live situation relating to a profession of the user.

18. The computer system of claim 15, wherein the simulated scenarios consisting of the user specific training data associated with training exercise/simulations.

19. The computer system of claim 15, wherein the one or more predictions further comprises, identifying opportunities to conserve oxygen and dynamically manage oxygen usage.

20. The computer system of claim 15, wherein the one or more recommendation further comprises, suggesting best route for the user to take during a live situation and alerting users to opportunities to conserve oxygen.
